(19) United States
(12) Patent Application Publication
(10) Pub. No.: US 2002/0011770 A1
(43) Pub. Date: Jan. 31, 2002

(54) Thin film type field emission display and method of fabricating the same

(75) Inventors: Steven Kim, Northvale, NJ (US); Geun Young Yeom, Seoul (KR); Do Haing Lee, Kyonggi-do (KR)

Correspondence Address: MORGAN, LEWIS & BOCKIUS, 1800 M STREET NW, WASHINGTON, DC, 20036-5869, US

(73) Assignee: SKION CORPORATION

(21) Appl. No.: 09/725,164

(22) Filed: Nov. 29, 2000

(30) Foreign Application Priority Data
Jun. 28, 2000 (KR) 2000-36066

(51) Int. Cl. H01J 1/62

(52) U.S. Cl. 313/310; 313/495; 445/24; 445/25

(57) ABSTRACT

A field emission display and a method of fabricating the same are disclosed in the present invention. The field emission display includes a glass substrate, an electron emitter on the glass substrate, a first electrode on the electron emitter having a first hollow substantially on the center thereon, an insulating layer on the first electrode having a second hollow in the vicinity of the first hollow, and a second electrode on the insulating layer having a third hollow located over the first and second hollows.

This application claims the benefit of Korean Application No. 10-2000-0036066 filed Jun. 28, 2000, which is hereby incorporated by reference.

### BACKGROUND OF THE INVENTION

1. Field of the Invention

The present invention relates to a display device, and more particularly, to a thin film type field emission display and a method of fabricating the same. Although the present invention is suitable for a wide scope of applications, it is particularly suitable for enhancing field emission efficiency by a thin film type cathode.

2. Discussion of the Related Art

Display devices have been an essential part of our daily life since the advent of television. Many efforts have been made to develop a new type of displays as well as to overcome disadvantages of the conventional displays, such as a cathode ray tube (CRT). The CRT is an excellent display in terms of performance. Also, the CRT has many beneficial features, such as a simple fabrication process, high brightness, a high dynamic range, perfect colors, an excellent color purity, a wide viewing angle, and a high resolution. Nonetheless, the CRT has the most fatal disadvantage of a huge nonlinear increase in volume or weight as a size of the screen increases.

In order to overcome such a disadvantage, there have been continuous efforts to develop various new display devices, such as an LCD (liquid crystal display), a PDP (plasma display panel), an ELD (electro luminescent display), and a VFD (vacuum fluorescent display), and the like. However, the above-described devices have the following problems yet to be solved.

More specifically, a PMLCD (passive-matrix LCD), the first commercially available display technology, transmits a polarized light through a liquid crystal thin film of which an orientation is fixed by a field applied thereto. Accordingly, the PMLCD requires a very bright backlight to avoid interferences from the ambient light source. Since the liquid crystals have an intrinsically slow responsive speed, brightness or colors of the transmitted light varies with a viewing angle, a temperature, and a pressure. In addition, there is another problem in reproducibility of the liquid crystals.

In a TFT-LCD using an active-matrix, a color filter is required for each color. Further, at least one transistor is required for each pixel. The number of transistors should be increased for a better resolution. Thus, the TFT-LCD has disadvantages in that its display function may be seriously damaged even if there is only one defective transistor in the TFT-LCD. Moreover, a production cost is high while a yield is low. Also, quality control is difficult.

An ELD has the following problems. First of all, luminous efficiency is low especially in the blue wavelength range. A luminous intensity is low while an operation range is small. Thus, to obtain a perfect color is difficult. Also, a refreshing rate drops due to high capacitance when electrodes are located too close each other in lowering an operative voltage.

A PDP has the following disadvantages. A substantial amount of gas is required for enhancing luminous intensity, which limits a minimum size of pixels and screens. Moreover, an omni-directional output (i.e., a light emission from the pixel is three dimensional) may cause cross-talks between pixels. As a result, a display resolution and an operation range should be sacrificed to avoid the cross-talks.

A VFD requires all electron sources to be turn-on throughout the entire operation period. Thus, the VFD has low power efficiency which is a serious problem especially in large size displays. Further, when electrons accelerated by a high voltage collide onto the sulfur-based phosphides, a sulfur gas is generated in the device. As a result, the sulfur gas causes corrosion on a cathode.

On the other hand, an FED has some advantages over the previously described displays. For example, a device structure is simple because a cathode and a gate may be formed on the same substrate. Also, a power consumption is low because the FED utilizes a cold cathode type. A size of the FED is not limited because internal supports are used between two glass substrates. An operation speed is fast while a viewing angle is wide. More importantly, a resolution and a luminous intensity are high while color performance is almost perfect.

A related art FED will be explained with reference to the attached drawings. FIGS. 1A to 1C illustrate various types of field emission cathodes.

Generally, an FED is provided with a cathode panel and an anode panel for displaying images when electrons emitted from the cathode panel hit the fluorescent material on the anode panel. The FED has a similar operation principle to the existing Braun tube. However, it has many advantages over Braun tube, such as a thin shape, lower power consumption, a lower fabrication process cost, excellent temperature characteristics, a fast operation, and the like.

A field emission is a phenomenon in which an electron emission from the surface of a material is caused by applying high electric fields. Many researches are underway for utilization of the field emission in flat panel displays, and the like. Molybdenum (Mo) or silicon (Si) is widely used as a cathode material for an field effect electron emission due to a high electron affinity The cathode is fabricated to have a sharp conic tip to generate electric fields enough to cause an electron emission. However, it is widely known that such a cathode tip has many problems in stability of the cathode. This is because high electric fields are concentrated on the cathode tip for the field emission. Thus, electron emission efficiency is gradually degraded by a back-sputtering or a chemical reaction with the residual gases.

For solving such problems, diamond-like carbon (DLC) has been employed as a cathode material. It is well known that carbon group materials have a negative electron affinity causing an electric emission even with low electric fields. Unlike the cathode formed of molybdenum or silicon, a sharp tip structure is not required in the carbon group material cathode. Thus, a fabrication process may be much simplified in the carbon group material cathode. In addition, the cathode using the carbon group material has good stability because the carbon group material has an excellent mechanical property, thereby reducing the damages from the back-sputtering. It has also superior physical and chemical properties, such as chemical stability, a high thermal conductivity, and the like.

A principle of the field emission utilized by a field emission device will be explained as follows. When a field over about 5×107 V/cm² is applied onto the surface of a solid (metal or conductor) under a vacuum condition, electrons are emitted from the solid to the vacuum by quantum tunnelling. A current-voltage characteristic can be expressed by the Fowler-Nordheim law as shown in equation (1) below.

$$I = \frac{A}{ψ} ( β {E}^{2} ) exp ( - \frac{B {ψ}^{\frac{3}{2}}}{β E} ) \qquad ( 1 )$$

Where, ‘I’ denotes an emission current, ‘E’ denotes an applied voltage, ‘ψ’ denotes a work function of a conductor, ‘β’ denotes a local field enhancement factor, and ‘A’ and ‘B’ denote constants. According to the equation (1), a work function should be low to obtain a high current at a low voltage. For example, when a radius of the end of the tip is 250 Å and a distance between the tips is 6000 Å for a typical Spindt type cathode, a current of 10 μA per tip can be obtained when 100 V is applied to the gate and the cathode. The current in the range of 100 μA per tip can also be obtained at a voltage below 100 V. This is possible when a current intensity in the range of 1000 A/cm² if the tips are packed to be a density of 107 tips/cm². This is 2000 times higher than a current density of 0.5 A/cm² which is available from a thermal electron emissive vacuum device and 10 times higher than a current density of 100 A/cm² of a solid state device. A high current density is very important in sustaining high brightness especially in a large size display, such as a high definition TV (HDTV). Thus, an FED is one of the most promising candidates for an application in the HDTV.

A related art FED will be further explained in detail as follows. Different cathode structures have been studied for enhancing an emission current or lowering an operative voltage in the FED. Also, many fabrication processes have been developed for optimizing the cathode structure. Currently, there are three types in contention: a cone type, a wedge type, and a thin film type, which are shown in FIGS. 1A to 1C. A Spindt type cathode is classified as the cone type.

FIG. 1A illustrates a cone type cathode structure. In this type, a micro-fabrication technology using an electron beam or a LOCOS has been employed to reduce a gate diameter. Also, diamond or DLC thin film has been employed as a cathode material in an effort to lower a work function. Among the cathode structures for an FED, a cone shape type is the most widely used cathode structure. The cathode tip may be formed of silicon or a metal (preferably, a refractory metal such as molybdenum). As shown in FIG. 1A, a cone type cathode is provided with a cathode layer 2 on a glass substrate 1. Another insulating layer 3 on the cathode layer 2 has a hole with a first diameter at the top portion and a second diameter at the bottom portion. The second diameter is smaller than the first diameter. A field emission cathode 5 has a cone shape on the central portion of the hole in the insulating layer 3 and in contact with the cathode layer 2. The field emission cathode 5 has a third diameter at the bottom portion. The third diameter is smaller than the second diameter. Further, a gate electrode 4 is formed on the insulating layer 3 having a hole with a fourth diameter located at the center of the field emission cathode 5. The fourth diameter is smaller than the first diameter.

Referring to FIG. 1B, a wedge type cathode is provided with a cathode layer 7 on a glass substrate 6. An insulating layer 8 is formed on the cathode layer 7 and has a groove therein. A field emission cathode 10 having a triangular sectioned wedge structure is located at the center of the groove in the insulating layer 8 and in contact with the cathode layer 7. A gate electrode 9 on the insulating layer 8 has an opening narrower than an opening of the groove formed in the insulating layer 8. The field emission cathode 10 is located at the center of the groove.

FIG. 1C illustrates a thin film edge type cathode. In this type, a cathode layer 12 is formed on a glass substrate 11. A lower electrode layer 13 on the cathode layer 12 has a groove therein. A first insulating layer 14 on the lower electrode layer 13 has an opening larger than an opening in the lower electrode layer 13. A field emission cathode 15 having a thin film form on the first insulating layer 14 has an opening with the same size as the opening in the lower electrode layer 13. A second insulating layer 16 on the field emission cathode 15 also has an opening with the same size as the opening in the first insulating layer 14. Further, an upper electrode layer 17 on the second insulating layer 16 has an opening with the same size as the opening in the lower electrode layer 13.

In the aforementioned related art cathode structures, when the diameter of the opening is greater than a thickness difference between the thickness of the field emission cathode and the total thickness of the insulating layers, a field emission efficiency becomes improved. Thus, a wide opening may provide a greater amount of electron emission. However, in such a case, an amount of electrons hitting onto the gate electrode is increased, thereby causing a current leakage. Moreover, it causes a poor electron focusing on the fluorescent material of the upper substrate, which deteriorates an image. Therefore, it is required to optimize dimensions and conditions by considering all the necessary factors. Also, the related art structures of the cathode and the method of fabricating the same has a limitation in design freedom that causes a problem in improving device characteristics and a yield.

### SUMMARY OF THE INVENTION

Accordingly, the present invention is directed to a thin film type field emission display and a method of fabricating the same that substantially obviate one or more of the problems due to limitations and disadvantages of the related art.

An object of the present invention is to significantly enhance field emission efficiency

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the field emission display includes a glass substrate, an electron emitter on the glass substrate, a first electrode on the electron emitter having a first hollow substantially on the center thereon, an insulating layer on the first electrode having a second hollow in the vicinity of the first hollow, and a second electrode on the insulating layer having a third hollow located over the first and second hollows.

In another aspect of the present invention, a method of fabricating a field emission display on a glass substrate includes the steps of forming an electron emitter on the glass substrate, forming a first electrode on the electron emitter having a first hollow substantially on the center thereon, forming an insulating layer on the first electrode, forming a second electrode on the insulating layer, and forming a second hollow in the insulating layer in the vicinity of the first hollow.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1A to 1C illustrate related art structures of cathodes of field emission devices;

FIG. 2A and 2B are cross-sectional and perspective views illustrating a structure of the cathode of a field emission device (“FED”) in accordance with a preferred embodiment of the present invention, respectively;

FIG. 3 illustrates a flow chart for a method of fabricating the FED in accordance with a preferred embodiment of the present invention;

FIGS. 4A and 4B are photographs taken by a scanning electron microscope (“SEM”) illustrating cross-sectional and plane views of a wet-etched lower electrode according to the present invention;

FIGS. 5A and 5B are SEM photographs illustrating cross-sectional views each showing a hard-baked photoresist layer at 140° C. and a dry-etched lower electrode layer according to the present invention;

FIGS. 6A and 6B are SEM photographs illustrating cross-sectional views each showing a hard-baked photoresist layer at 170° C. and a dry-etched lower electrode layer according to the present invention;

FIGS. 7A and 7B are SEM photographs illustrating cross-sectional views each showing a hard-baked photoresist layer at 200° C. and a dry-etched lower electrode layer according to the present invention;

FIG. 8 is an SEM photograph illustrating a cross-sectional view of the lower electrode after completion of both dry-etching and wet-etching the lower electrode according to the present invention;

FIG. 9 is an SEM photograph illustrating a cross-sectional view of the lower electrode after successively dry-etching, removing residues, and wet-etching the lower electrode according to the present invention;

FIG. 10 is an SEM photograph illustrating a cross-sectional view of the insulating layer after successively forming and wet-etching the insulating layer according to the present invention;

FIG. 11 is an SEM photograph illustrating a cross-sectional view of the insulating layer deposited by RF magnetron sputtering and e-beam evaporation at the same time according to the present invention;

FIG. 12 is an SEM photograph illustrating a cross-sectional view of the insulating layer deposited by RF magnetron sputtering and e-beam evaporation at the same time and etched by wet-etching according to the present invention;

FIG. 13 is an SEM photograph for a cross-sectional view of the insulating layer showing a progress of wet-etching along a boundary of the insulating layer according to the present invention;

FIG. 14 is an SEM photograph for a cross-sectional view of the insulating layer showing a progress of wet-etching the insulating layer deposited by RF magnetron sputtering and e-beam evaporation at the same time at a 600° C. substrate temperature and a 3 Å/s deposition rate according to the present invention;

FIG. 15 is an SEM photograph for a cross-sectional view of the insulating layer having a photoresist layer thereon after the insulating layer is formed to have a thickness greater than the planarization thickness of the insulating layer by the thickness for a lower electrode;

FIG. 16 is a graph illustrating changes in etching rates for the insulating layer and the photoresist layer in accordance with changes of O₂ contents in an etching gas according to the present invention.

FIG. 17 is an SEM photograph for a cross-sectional view after completion of the planarization with an etching gas having 10% O₂ contents according to the present invention;

FIG. 18 is a table showing etching rates for Mo and SiO₂ under the various process conditions according to the present invention;

FIG. 19A is an SEM photograph for a cross-sectional view of a patterned mask oxide layer to etch a Mo layer according to the present invention;

FIG. 19B is an SEM photograph for a cross-sectional view of the Mo layer patterned by using the oxide layer as a mask;

FIG. 20 is an SEM photograph for a front view of a completed cathode of the FED in accordance with a preferred embodiment of the present invention; and

FIG. 21 is an SEM photograph for a cross-sectional view of a completed cathode of the FED in accordance with a preferred embodiment of the present invention.

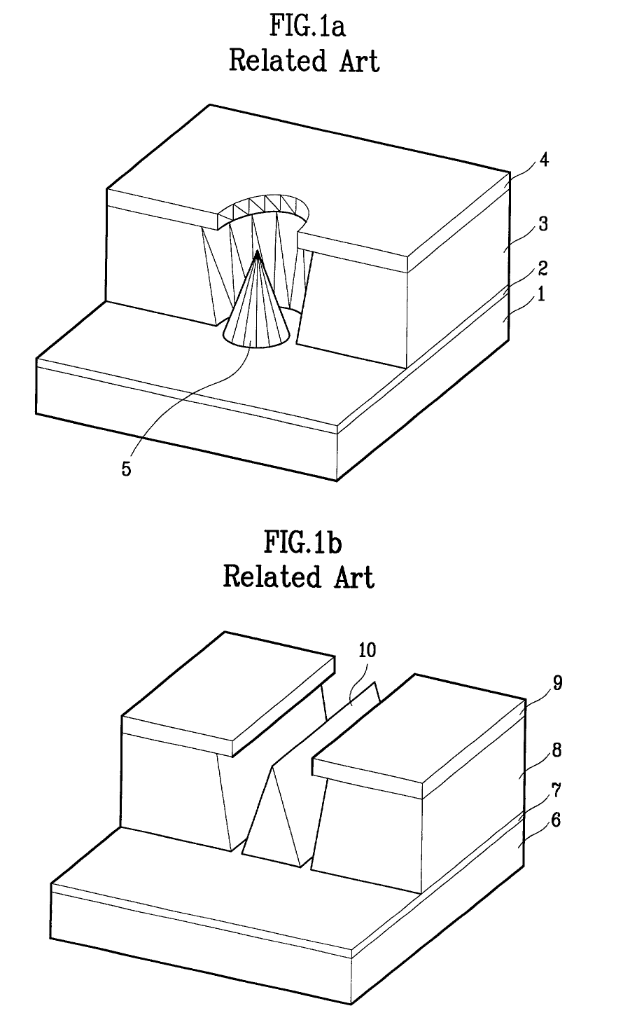

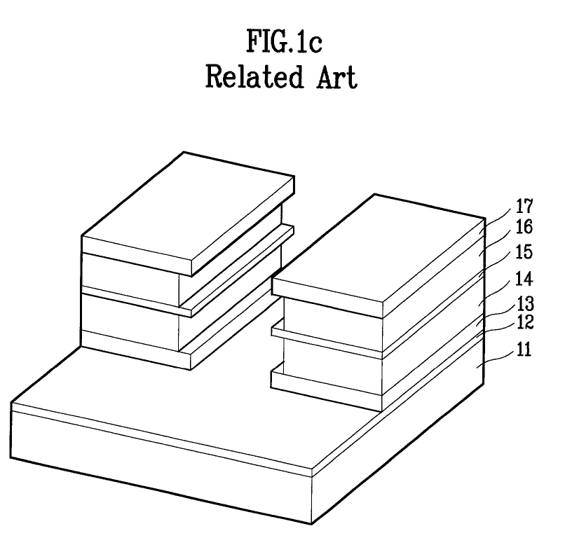

### DETAILED DESCRIPTION OF THE PREFERRED EMBODIMENTS

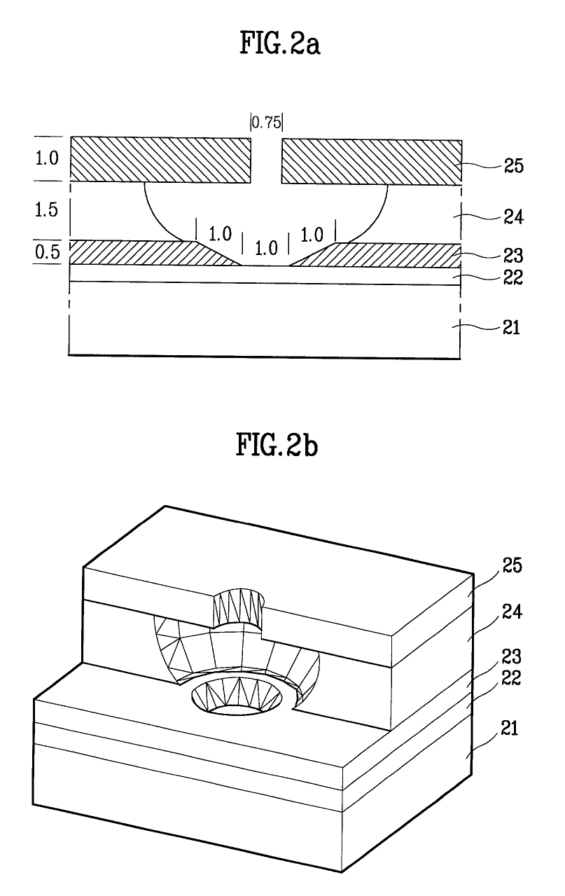

Reference will now be made in detail to the preferred embodiments of the present invention, examples of which are illustrated in the accompanying drawings FIGS. 2A and 2B are cross-sectional and perspective views illustrating a cathode structure of a field emission device in accordance with a preferred embodiment of the present invention, respectively.

Initially referring to FIGS. 2A and 2B, a cathode of a field emission device in accordance with a preferred embodiment includes an electron emitter 22 (for example, diamond-like carbon (DLC)) on a glass substrate 21, a lower electrode 23 (for example, a refractory metal such as molybdenum) on the electron emitter, an insulating layer 24 formed of SiO₂ on the lower electrode 23, and an upper electrode 25 (for example, a refractory metal such as molybdenum) on the insulating layer 24. The present invention is a thin film type FED which provides the best electron emission efficiency and makes electrons to travel straight. Preferably, the lower electrode 23, the insulating layer 24, and the upper electrode 25 have thicknesses with a ratio of 1:3:2, respectively. Also, the lower electrode 23 has a shape with a ratio of the exposed portion of the electron emitter 22 and the etched two side slopes to be 1:1:1, as shown in FIG. 2A. In this instance, a ratio of the thickness of the lower electrode 23 and the exposed portion of the electron emitter 22 is 1:2. A ratio of the thickness of the lower electrode 23 and a hole size of the upper electrode 25 is 1:1.5.

A structure of the FED of the present invention will be explained in more detail. As shown in FIGS. 2A and 2B, the FED of the present invention includes an electron emitter 22 (for example, a DLC layer) formed on a glass substrate 21 having a thickness of 250 to 350 Å, preferably 300 Å. A lower electrode 23 (for example, a molybdenum layer) formed on the electron emitter 22 has a first region with a first hole having a portion of the electron emitter removed therefrom, a second region centred on and in continuation with the first region with a slope having an angle of 26.5°, so that the edge thickness of the first hole gradually increases as the slope goes away from the center, and a third region outside the second region with a uniform thickness. Accordingly, the first hole has a frustoconical shape.

An insulating layer 24, such as SiO₂, on the third region of the lower electrode 23 has a uniform thickness with an outward round shape in the center. The insulating layer 24 is not in contact with the second region and spaced apart therefrom. An upper electrode 25, such as a refractory metal, preferably molybdenum, is formed on the insulating layer 24. The upper electrode 25 has a third hollow over the first and second hollows which has a segmented cylindrical shape. A diameter of the third hollow is smaller than the first hollow in the lower electrode 23.

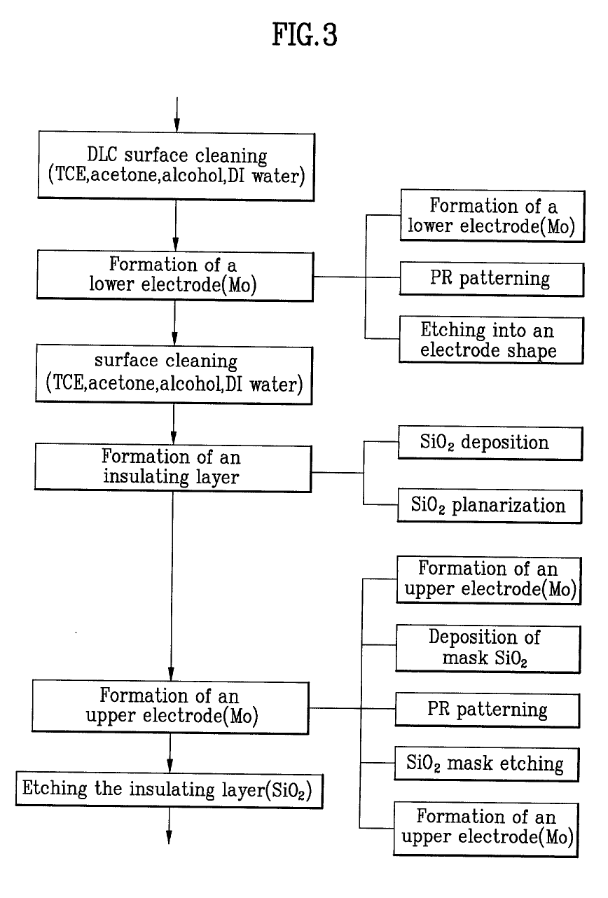

A method of fabricating a cathode of an FED in accordance with a preferred embodiment of the present invention will be explained. FIG. 3 illustrates a flow chart for a fabrication method of an FED in accordance with a preferred embodiment of the present invention.

An electron emitter 22, preferably formed of a DLC layer, is formed on a glass substrate 21. The surface of the electron emitter 22 is then cleaned. As a process for forming a lower electrode 23, a refractory metal layer, preferably molybdenum, is formed on the electron emitter 22 and patterned to form an electrode by photolithography. Then, the entire surface is cleaned including the lower electrode 23.

In the next step, an insulating layer 24 is formed on the entire surface including the lower electrode 23 by depositing and planarizing SiO₂ layer. In forming an upper electrode 25, a refractory metal layer such as molybdenum and a mask oxide layer are formed on the insulating layer 24. Thereafter, the oxide layer is patterned by photolithography. The refractory metal layer is then patterned to have a form of an electrode by using the mask oxide layer as a mask. Successively, the insulating layer 24 is etched by using the patterned upper electrode 25 as a mask.

In the foregoing process, for example, the DLC layer 22 may be deposited by Cs⁺ ion assisted sputtering. The Cs⁺ ion assisted sputtering improves a sputtering process by utilizing the feature that Cs⁺ ions provide the greatest probability of cation emission when the Cs⁺ ions hit the Cs target. In a plasma discharge process of forming the electron emitter 22 of the DLC layer, the Cs⁺ ions are emitted from the Cs target located at the center of the graphite target. The Cs⁺ ions hit the graphite target in turn, thereby emitting C⁻ ions, which are accelerated by potential until the C⁻ ions hit the substrate. As a result, a good quality of DLC layer is formed thereon.

DC magnetron sputtering, for example, may be used in forming the molybdenum layers for both the upper and lower electrodes on the electron emitter 22. The insulating layer 24 may be formed by one of e-beam evaporation, RF magnetron sputtering, and ion beam assisted evaporation. However, it is preferable that inductively coupled plasma equipment is used for etching the molybdenum layer for forming both the lower electrode 23 and the upper electrode 25. Magnetically enhanced inductively coupled plasma equipment may be used for etching the mask oxide layer. Moreover, it is preferable that the inductively coupled plasma equipment has a chamber formed of anodized aluminum. A 13.56 MHz RF power is applied to water-cooled helical copper coils having 3.5 times turns in forming plasma. A distance between the silica window separating the coil from the chamber and the substrate is maintained to be 65 mm. In order to sustain a bias voltage, a 13.56 MHz RF power is separately applied to the substrate. It is also preferable that the magnetically enhanced inductively coupled plasma equipment has a chamber made of stainless steel. A 13.56 MHz RF power is applied to water cooled helical copper coils having 5 times turns in forming inductively coupled type plasma. In order to sustain a bias voltage, a 13.56 MHz RF power is separately applied to the substrate. To increase a magnetic field in the chamber, four pairs of permanent magnets are provided at the equal distances around the chamber. Each magnet has a size of 1 cm×10 cm and a magnetic field of 2000 Gauss at the surface. A thickness of the silica window which separates the coil from the chamber is set to be 1 cm. A distance between the substrate and the silica window is about 75 mm.

Now the overall steps for fabricating the FED of the present invention will be explained in detail. Initially, the steps of fabricating a lower electrode 23 will be explained.

An electron emitter 22 formed of a DLC layer is deposited using Cs⁺ ion assisted sputtering to have a thickness of 250 to 350 Å, preferably to 300 Å. The lower electrode 23 is formed of molybdenum. The DLC layer 22 on the glass substrate 21 is cleaned by using a Tri-Chloro-Ethylene (TCE) solution, ethanol, or extra pure water (or deionized water). A molybdenum layer is deposited by DC magnetron sputtering. In this process, aluminum is not the choice of material for the lower electrode because aluminum can be etched by a BOE solution, which is a wet-etching solution of the insulating layer such as SiO₂. The deposition of molybdenum is carried out under conditions, such as an initial vacuum of 2×10⁻⁵ Torr and a 10 sccm flow rate of an Ar gas. A throttle valve of the chamber is adjusted to maintain a process pressure at about 5 mTorr. After depositing the molybdenum for the lower electrode, dry-etching is processed by using a photoresist layer as a mask to form an electrode shape. In this process, after forming a photoresist pattern by photolithography, a baking temperature of the photoresist pattern may be adjusted to reduce a sharp portion of the photoresist pattern in the vertical direction.

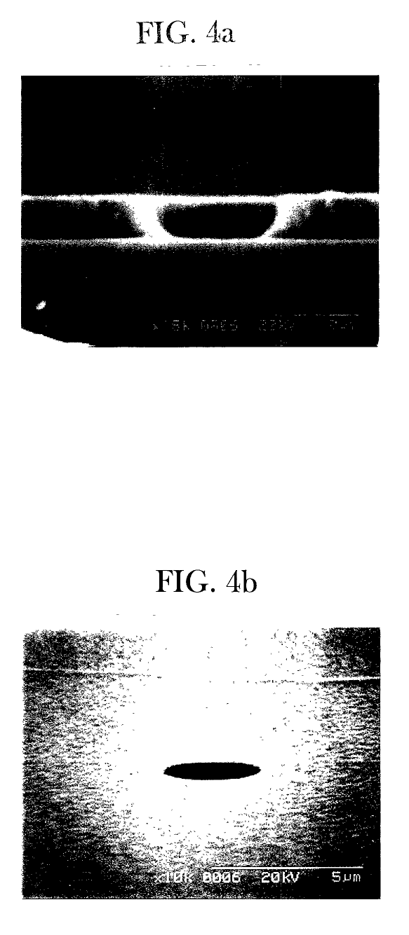

FIGS. 4A and 4B are scanning electron microscope (SEM) photographs illustrating cross-sectional and plan views of the wet-etched lower electrode. The molybdenum layer is wet-etched by using a mixed solution of CH₃COOH, H₃PO4, HNO₃, and H₂O at a ratio of 6:7.6:3:15 at an etching rate of about 850 Å/min. Referring back to FIG. 4A, the molybdenum layer may not have a 26.5° slope when the molybdenum layer is patterned by wet-etching. Therefore, the molybdenum layer should be patterned by dry-etching in the present invention. In other words, in etching the molybdenum layer to form the lower electrode 22, an etching process is carried out under the following conditions by using inductively coupled plasma equipment. The etching is processed at an inductive power of 400 w, a bias voltage of 150 V at a process pressure of 20 mTorr using a pure Cl₂ gas as an etching gas. In this process, a temperature of the substrate is maintained at 70° C. The molybdenum layer is etched at an etching rate of 2900 Å/min. In order to prevent a damage on the surface of the electron emitter 22 formed of a DLC layer by the dry-etching, an uppermost portion of about 500 Å of the molybdenum layer is etched by wet-etching using a wet-etching solution of a mixture of 38H₃PO₄+15HNO₃+30CH₃COO+75H₂O at a ratio of 6:7.6:3:15. Also, for providing a low-angle etching slope of the molybdenum layer for the lower electrode 23, a side slope of the photoresist acting as an etching mask is to have a small angle by hard-baking of the photoresist at a high temperature.

The hard-baking temperature of the photoresist and etching results of the molybdenum layer will be explained in more detail.

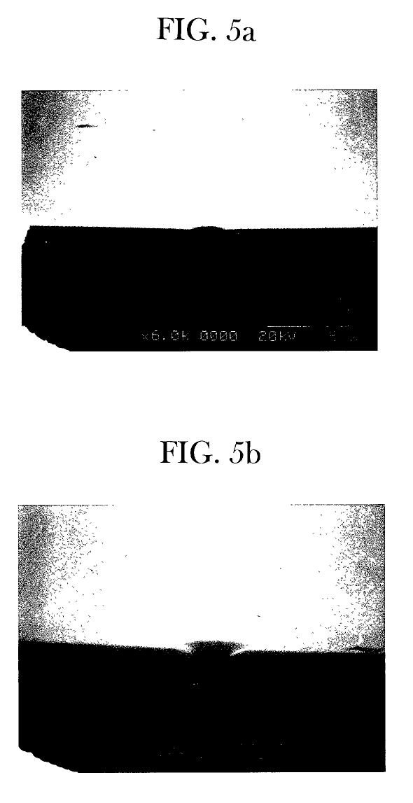

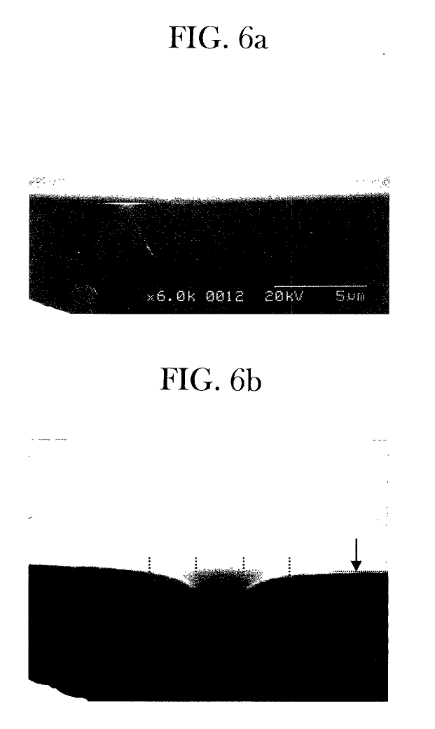

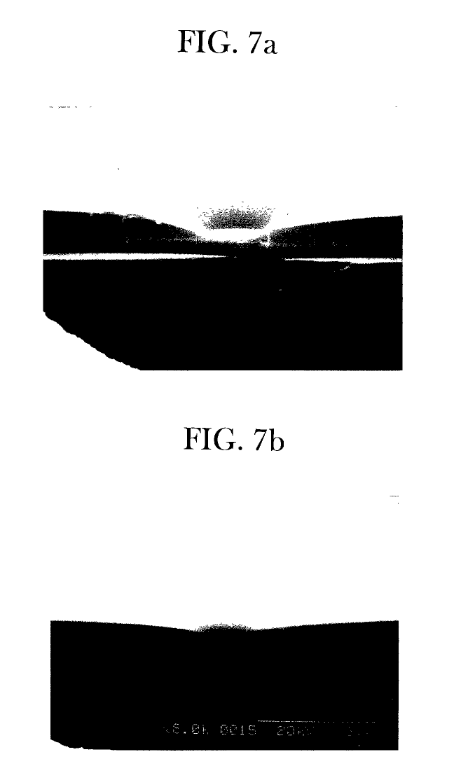

FIGS. 5A and 5B are SEM photographs for cross-sectional views each showing a hard-baked photoresist layer at 140° C. and a dry-etched lower electrode layer, respectively. FIGS. 6A and 6B are SEM photographs for cross-sectional views each showing a hard-baked photoresist layer at 170° C. and a dry-etched lower electrode layer, respectively. FIGS. 7A and 7B are SEM photographs for cross-sectional views each showing a hard-baked photoresist layer at 200° C. and a dry-etched lower electrode layer, respectively.

As shown in the above photographs, a mask having a low angle side slope is provided by elevating a hard-baking temperature of the photoresist, so that a side slope angle for the molybdenum layer is decreased after the molybdenum layer is etched. More particularly, as shown in FIGS. 6A and 6B, a side slope angle of the molybdenum layer can be optimized when the molybdenum layer is etched by using a hard-baked photoresist. The hard-baking is performed for 10 min at 170 ° C. A process time in the hard-baking does not affect the side slope angle of the molybdenum layer. In this process as shown in FIGS. 6A and 6B, although a desired shape, which is an etched side slope having an angle of about 26.5°, is obtained when the molybdenum layer is dry-etched, the substrate may be over-etched in this process. Since there should be no damage to the surface of the electron emitter 22 formed of a DLC layer for improving electron emission characteristics in fabricating a device, an etching process should be completed soon after the electron emitter 22 is exposed in patterning the lower electrode 23. Therefore, as explained, both the dry-etching and the wet-etching should be employed in the present invention in patterning the lower electrode 23 in order to avoid a damage to the electron emitter 22.

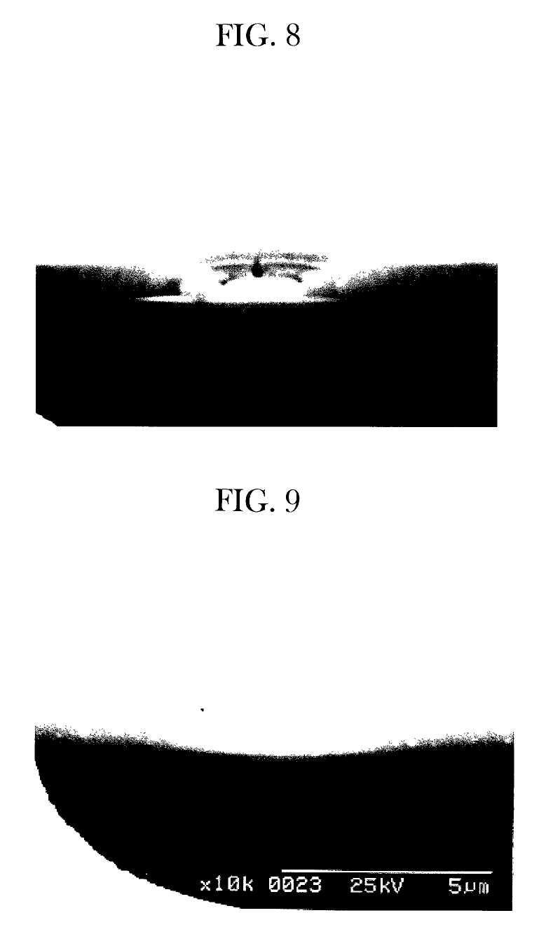

FIG. 8 is an SEM photograph for a cross-sectional view of a lower electrode etched by both dry-etching and wet-etching. As shown in FIG. 8, by employing both the dry-etching and the wet-etching, an over-etching of the bottom surface is prevented. Thus, a desired side slope angle is obtained.

However, there is still a problem in this process. A portion of the electrode remains unetched in the center due to residues of the photoresist during the dry-etching. The residues act as a mask on the surface. To eliminate such a problem, an O₂ plasma process may be carried out for 30 seconds in succession to the dry-etching for removing the photoresist residues by using inductively coupled plasma at a process pressure of 20 mTorr and applying a 500 W inductive power to the substrate.

FIG. 9 is an SEM photograph for a cross-sectional view of a lower electrode after completion of dry-etching, removal of residues, and wet-etching. The wet-etching is carried out after the photoresist residues on the surface of the molybdenum layer are removed to the extent that no damage is given to the photoresist by the O₂ plasma process. As shown in FIG. 9, unetched residual portions are avoided and an etching depth at the surface of the electron emitter 22 of a DLC layer is precisely controlled by using such a residue removal process.

Deposition and etching processes for an insulating layer 24 will be explained as follows.

The insulating layer 24 is formed of SiO2, and a deposition is carried out by one of e-beam evaporation, RF reactive magnetron sputtering, an ion beam assisted evaporation, or the like. It is preferable that the insulating layer 24 has a thickness about three times a thickness of the lower electrode 23. For enhancing a bonding force between the lower electrode 23 and the insulating layer 24, after the lower electrode 23 is patterned, the surface should be cleaned in an order of TCE, acetone, alcohol, and extra pure water (or deionized water) before the insulating layer 24 is formed thereon. When the insulating layer 24 is deposited by e-beam evaporation, the following process conditions preferable: an initial vacuum of below 2×10⁻⁵ Torr, an acceleration voltage of 3.2 kV, and a current in the range of 50 to 60 mA. Deposition efficiency may be improved by varying a substrate temperature in the range of 200° C. to 600° C. In the case that the insulating layer 24 is is deposited by RF magnetron sputtering, an initial vacuum of the deposition chamber is set to be below 2×10⁻⁵ Torr, an Ar gas flow rate is set to be 10 sccm, an O₂ gas flow rate is 0.5 sccm, and a throttle valve is adjusted to maintain a deposition pressure at 10 Torr. A deposition RF power is set at 200 W. On the other hand, when the insulating layer 24 is deposited by ion beam assisted evaporation, an initial vacuum is set to be below 9×10⁻⁵ Torr. An acceleration voltage is set to be 5.5 kV. Also, a current is set to be 50 to 60 mA. O₂⁺ ions are used as an ion beam source. A RF power for generating the O₂⁺ ions is set to be 100 W. An acceleration voltage for ion acceleration is set to be 900 V.

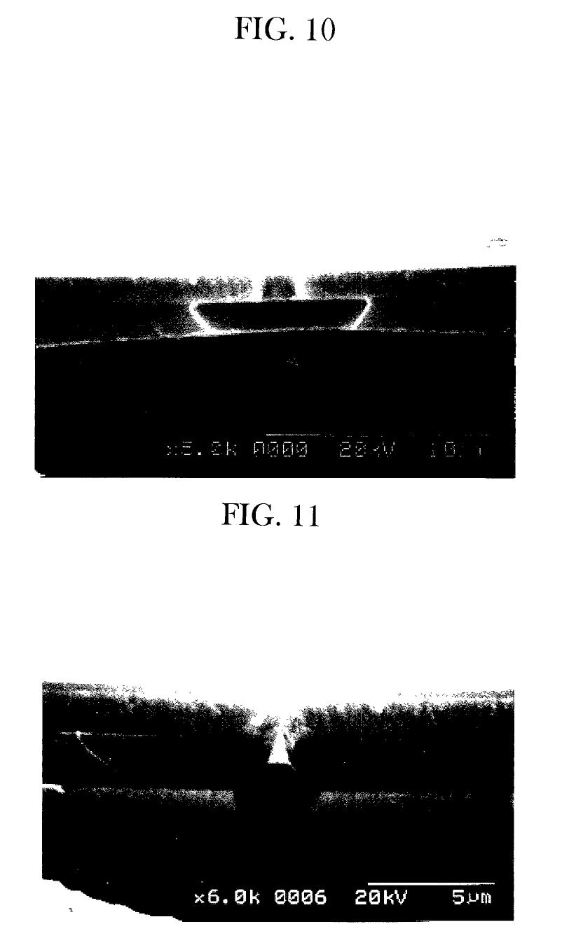

The following methods may be employed for enhancing a bonding force between the lower electrode 23 and the insulating layer 24. For example, in forming the insulating layer 24, when SiO₂ is deposited by e-beam evaporation at the room temperature, the layer may be peeled off right after the deposition, thereby causing a poor adhesion between the lower electrode 23 and the SiO₂ layer. Therefore, when the molybdenum layer is deposited by e-beam evaporation, a substrate temperature is set to be 200° C., and a vacuum heat treatment is carried out for about 30 min. Then, the molybdenum layer continues to be formed at the same temperature, thereby enhancing an adhesion between the molybdenum layer and the SiO₂ layer. However, when the SiO₂ layer deposited by e-beam evaporation is wet-etched using a BOE solution in patterning the SiO₂ layer, the wet-etching may further progress along the interface of the lower electrode and the SiO₂ layer as shown in FIG. 10.

FIG. 10 is an SEM photograph for a cross-sectional view of a wet-etched insulating layer showing a progress of the fast etching along the interface. Improving an adhesion by the heat treatment at the interface of the molybdenum layer and the SiO₂ layer is limited due to the progress of the fast etching. As an alternative to improve the adhesion between the lower electrode 23 and the insulating layer 24, a first SiO₂ layer is formed by RF-magnetron sputtering to have a thickness of 3000 Å and a second SiO₂ layer is formed by using e-beam evaporation to have a necessary thickness. The SiO₂ layers may be deposited by ion beam assisted evaporation. There may be a boundary within the SiO₂ layers depending on the shape of the lower electrode 23 in the SiO₂ layers formed by the e-beam evaporation and the ion beam assisted evaporation. This may cause an undesirable etched shape in the insulating layer 24 during the wet-etching. Therefore, it is preferable that a substrate temperature is elevated up to 600° C. and a deposition rate is maintained as low as about 3 Å/s in depositing the SiO₂ layers by the e-beam evaporation.

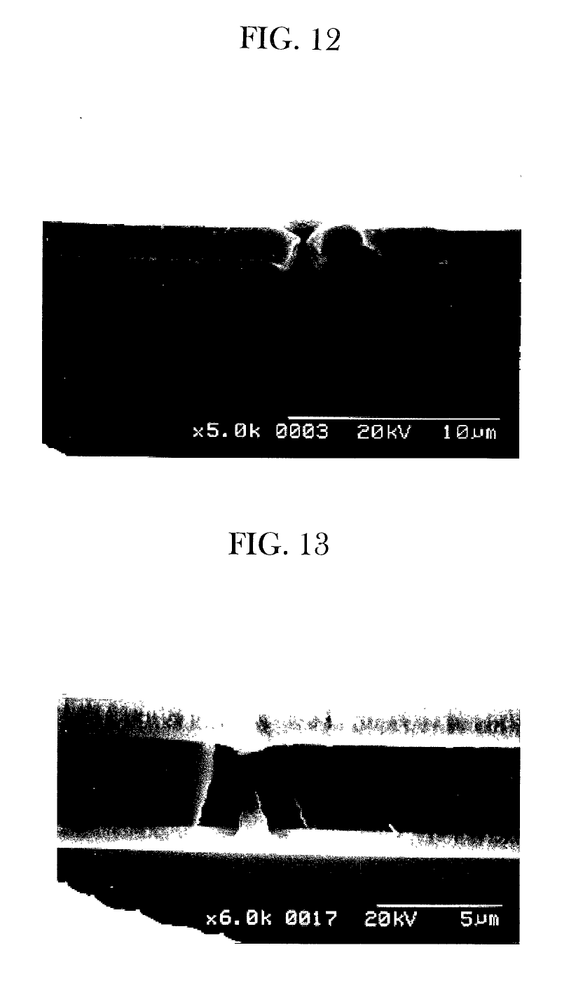

The foregoing processes are carried out because of the following reasons. FIG. 11 an SEM photograph for a cross-sectional view of an insulating layer deposited by both RF magnetron sputtering and e-beam evaporation, while FIG. 12 is an SEM photograph for a cross-sectional view of an insulating layer deposited by both RF magnetron sputtering and e-beam evaporation and etched by wet-etching.

As shown in FIG. 11, a boundary within the insulating layer 24 in forming the insulating layer 24 is formed by a shape of the lower electrode 23 due to a poor step coverage in forming a SiO₂ layer by e-beam evaporation. Further, as shown in FIG. 12, the insulating layer 24 wet-etched in a reverse shape because the wet etching progressed fast along the boundary, as shown in FIG. 11. The reverse shape of wet-etching is clearly shown in FIG. 13. FIG. 13 is an SEM photograph for a cross-sectional view showing a progress of the wet-etching along a boundary in the insulating layer 24. Therefore, it is desirable that a step coverage should be improved to eliminate the boundary within the SiO₂ layer formed in depositing the SiO₂ layer. Accordingly, in forming the SiO₂ layer by e-beam evaporation, a substrate temperature is elevated to 600° C. and a deposition rate should be lower to about 3 Å/s for improving a step coverage.

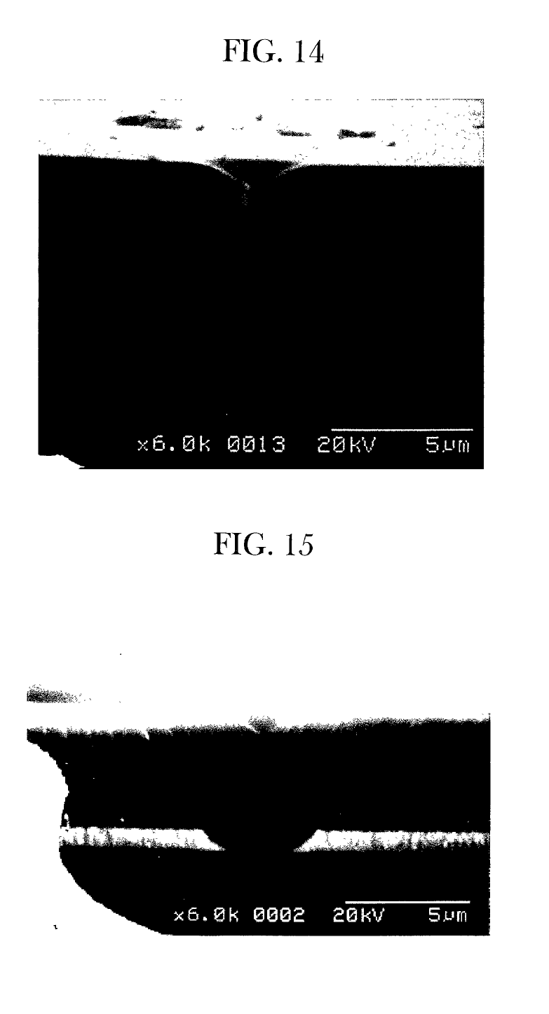

In FIG. 14, an SEM photograph for a cross-sectional view of the wet-etched SiO₂ layer formed by e-beam evaporation. As shown in FIG. 14, a reverse shape of the SiO₂ layer formed by the boundary of the SiO₂ layer becomes a desired shape. FIG. 14 is an SEM photograph for a cross-sectional view showing a progress of wet-etching the insulating layer deposited by using both RF magnetron sputtering and e-beam evaporation at a 600° C. substrate temperature and a 3 Å/s deposition rate. The etching rate may vary with locations of the insulating layer 24 due to changes in a SiO₂ density caused by a different deposition rate. By using a RF reactive magnetron sputtering method, a SiO₂ layer without a boundary can be obtained due to a low deposition rate which eliminates a generation of the reverse shape by wet-etching. Also, a SiO₂ layer having a smooth surface may be obtained because of a constant deposition rate, which permits a constant wet-etching rate. Thus, as set forth above, it is preferable that the insulating layer 24 is deposited by RF reactive magnetron sputtering.

In FIGS. 12 and 14, the insulating layer 24 has a recess caused by the shape of the lower electrode 23. The recess in the insulating layer 24 causes the upper electrode 25 to have a recess in the following process. To eliminate such a problem, a planarization process for the insulating layer 24 is carried out in the present invention. For example, a photoresist is coated after the SiO₂ layer is deposited to fill up the recess of the insulating layer 24. The coated photoresist and the SiO₂ layer are then etched by the same etching rate for a planarization. Etching is carried out by using magnetically enhanced inductively coupled plasma equipment under process conditions of an inductive power of 1000 W and a bias voltage of about 100 V, and using an etching gas comprising a 90% CF₄ and 10% O₂ contents.

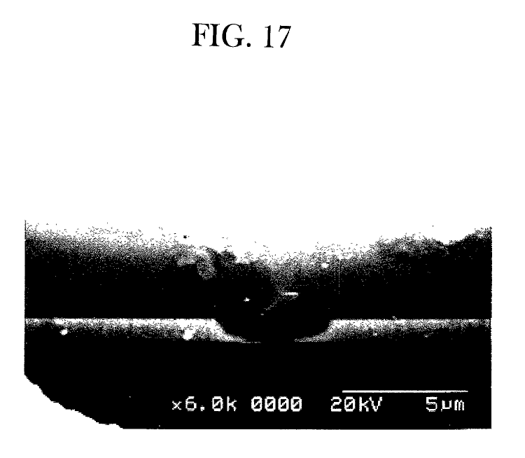

FIG. 15 is an SEM photograph for a cross-sectional view of an insulating layer having a photoresist layer thereon after the insulating layer is deposited to have a thickness greater that a thickness for planarization of the insulating by a thickness of a lower electrode. FIG. 17 is an SEM photograph for a cross-sectional view of a planarized insulating layer with an etching gas of a 10% O₂ content. For planarizing the insulating layer, an etching condition should be selected to etch the SiO₂ layer and the photoresist layer at the same etching rate. A CF₄ gas, the most widely used in etching the SiO₂ layer, is employed as a major etching gas. An O₂ gas, for effectively removing the photoresist layer, is used as an additive gas.

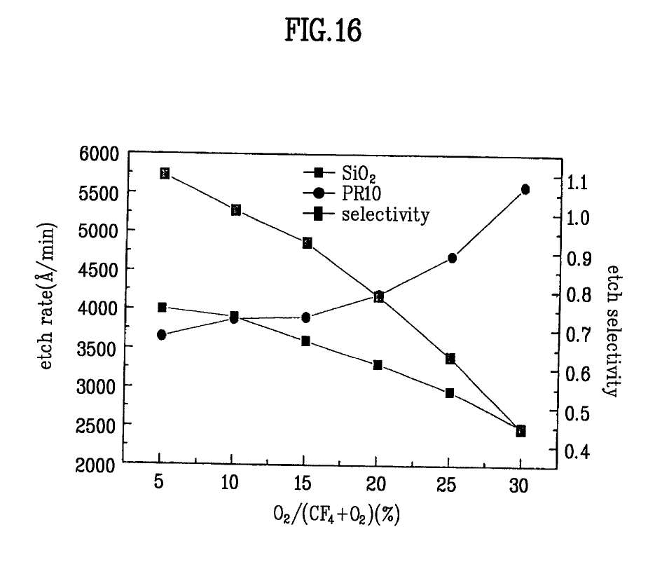

FIG. 16 is a graph showing etching rates for an insulating layer and a photoresist layer with changes an O₂ content in an etching gas. As shown in FIG. 16, the more O₂ is added to the CF₄ gas, the higher an etching rate of the photoresist layer is obtained. Thus, a lower etching rate of the SiO₂ layer is achieved. The etching rates for the SiO₂ layer and the photoresist layer are the same when an etching gas has 90% of a CF₄ gas and 10% of an O₂ gas. Thus, by employing such an etching condition, the insulating layer 24 has a flat top surface with no recess, as shown in FIG. 17.

Upon completion of the planarization of the insulating layer 24, depositing a molybdenum layer is carried out as follows for forming an upper electrode 25. The molybdenum layer is deposited by DC magnetron sputtering under an initial vacuum of below 2×10⁻⁵ Torr, an Ar gas flow rate of 10 sccm, and a pressure of 5 mTorr. The molybdenum layer is deposited to have a thickness twice the thickness of the lower electrode 23. Then, the molybdenum layer is patterned by the following etching process. Since the upper electrode 25 should be vertically etched, a material for the upper electrode 25 is required to have a high etching selectivity over a mask material. The etching mask is formed of SiO₂, and magnetically enhanced inductively coupled plasma equipment is used as a mask etching equipment. A mask oxide layer is deposited to have a thickness of 3500 Å by RF magnetron sputtering at an inductive power of 1000 W, and a bias voltage of about 100 V by using CF₄ as an etching gas. The mask oxide layer is used in patterning the molybdenum layer by using the inductively coupled plasma equipment in an etching gas of 50% Cl₂ and 50% O₂ for obtaining a high etching rate and an etching selectivity between the molybdenum layer and the SiO₂. Further, the following conditions are preferable: a process pressure of about 20 mTorr, an inductive power of 400 W, a bias voltage of about 150 V, and a substrate temperature of 70° C. A Cl₂ gas is used as a main etching gas while O₂ and BCl₃ gases are used as additive gases.

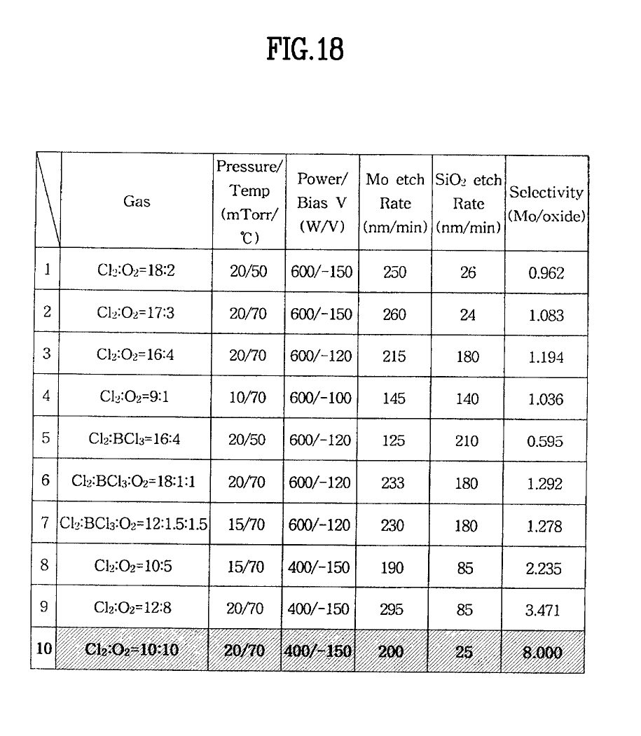

Variations in etching rates of molybdenum and SiO₂ with various process conditions are illustrated in FIG. 18. An etching rate varies with a process pressure, a substrate temperature, an inductive power, and a bias voltage. As shown in FIG. 18, a high etching rate and a high etching selectivity between molybdenum and SiO₂ are obtained in an etching gas of 50% Cl₂ and 50% O₂, at a process pressure of 20 mTorr, an inductive power of 400 W, a bias voltage of about 150 V, and a substrate temperature of 70° C.

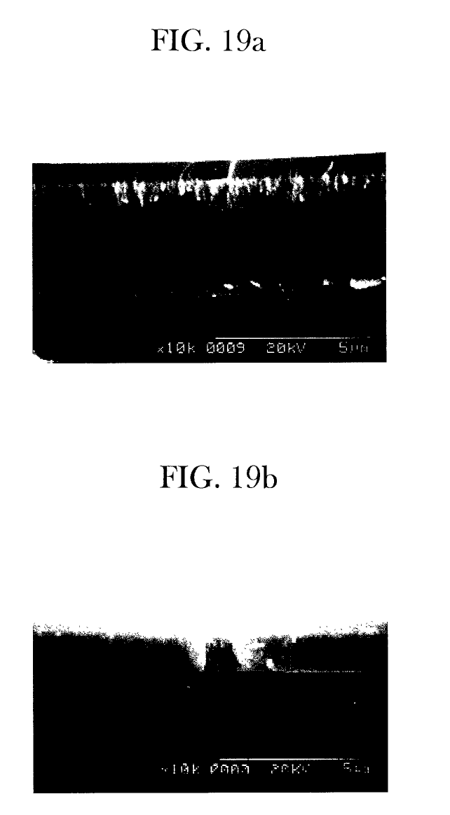

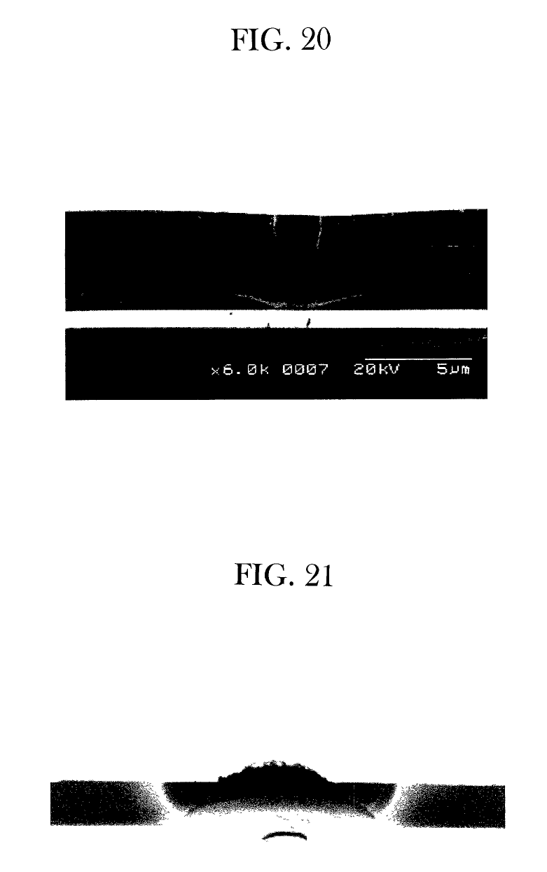

SEM photographs for cross-sectional views of a mask oxide layer and a molybdenum (Mo) layer of the foregoing processes are shown in FIGS. 19A and 19B. More specifically, FIG. 19A illustrates a cross-sectional view of a patterned mask oxide layer for etching a Mo layer. In FIG. 19B, the molybdenum layer is etched in the vertical direction. In FIG. 19B, a cross-sectional view of a patterned Mo layer by using a mask oxide layer. After patterning the upper electrode 25, the insulating layer 24 is etched by using a buffered oxide etching (BOE; 6:1) solution to complete a cathode as shown in FIGS. 20 and 21.

In order to more improve an electron emission efficiency of an FED in the present invention, the surface of the electron emitter 22 may be modified to have a micro-rough (micro-abraded) shape. This process may be carried out by wet or dry etching or ion beam etching. In the case of ion beam etching, the first electrode 23 is negatively biased while the second electrode 24 it is positively biased under a vacuum condition. Thus, the etching process is more effectively progressed.

FIGS. 20 and 21 are SEM photographs for front and cross-sectional views of a completed cathode of the FED in accordance with a preferred embodiment of the present invention, respectively.

Since the FED of the present invention has an emission array consisting of upper electrodes and lower electrodes, it implements colors more accurately. In addition, it provides a high resolution because an electron beam tends to have a straight travelling characteristic comparing to that from other types of electrodes.

As explained above, the thin film type field emission display and the method of fabricating the same of the present invention have the following advantages.

First of all, as a cathode is formed of a DLC thin layer with optimized process conditions, FED efficiency is much enhanced. Due to great design freedom in forming an insulating layer and a gate electrode, device characteristics and a yield are improved. Also, a desired electrode shape is obtained by selecting molybdenum as a lower electrode and employing a hard-baked photoresist as an etching mask. A device uniformity and desirable operation characteristics are achieved because wet-etching is successively followed by dry-etching in patterning the lower electrode to avoid damages to the surface of the DLC thin layer.

An employment of RF reactive magnetron sputtering in forming an insulating layer enhances an adhesion between the lower electrode and the insulating layer. As a result, wet-etching characteristics are improved in successive processes. An adhesion between the lower electrode and the insulating layer is improved because the surface of the lower electrode is cleaned in order of TCE, acetone, alcohol, and extra pure water.

In addition, planarization of the insulating layer prevents deterioration in device performance, which comes from a recess in the insulating layer caused by the shape of the lower electrode. In forming an upper electrode, a high etching rate and a high etching selectivity of the molybdenum layer to the SiO₂ mask in patterning the molybdenum layer allow an optimum patterning of the upper electrode. As a result, a device uniformity and reproducibility are increased.

An emission array having lower and upper electrodes allows an accurate implementation of colors. Further, a straight travelling characteristic of electron beams from the cathode of the present invention is better than those of tip shaped cathodes. Accordingly, a high resolution image is obtained in the present invention.

It will be apparent to those skilled in the art that various modifications and variations can be made in the field emission display and method for fabricating the same of the present invention without departing from the spirit or scope of the invention. Thus, it is intended that the present invention covers the modifications and variations of this invention provided they come within the scope of the appended claims and their equivalents.

What is claimed is:

1. A field emission display comprising:
a glass substrate;
an electron emitter on the glass substrate;
a first electrode on the electron emitter, having a first hollow substantially on the center thereon,
an insulating layer on the first electrode, having a second hollow in the vicinity of the first hollow; and
a second electrode on the insulating layer having a third hollow located over the first and second hollows.

2. The display according to claim 1, wherein the first electrode, the insulating layer, and the second electrode have a relative thickness ratio of 1:3:2.

3. The display according to claim 1, wherein a thickness of the first electrode and a diameter of the third hollow have a relative ratio of 1:1.5.

4. The display according to claim 1, wherein the first, second, and third hollows are frustoconical, segmented ball, and segmented cylindrical shapes, respectively.

4. The display according to claim 1, wherein the first hollow has first and second diameters and the third hollow has a third diameter, wherein the second diameter is greater than the first diameter and the first diameter is greater than the third diameter.

5. The display according to claim 4, wherein the first diameter is twice greater than a thickness of the first electrode.

6. The display according to claim 4, wherein the first diameter of the first hollow exposes a portion of the electron emitter.

7. The display according to claim 4, wherein the first and third diameters have a relative ratio 1:0.75.

8. The display according to claim 4, wherein the first diameter is substantially the same as the shortest distance between the first and second diameter along a frustoconical surface of the first hollow.

9. The display according to claim 1, wherein the electron emitter has a thickness of about 250 to 350 Å.

10. The display according to claim 1, wherein the first and second electrodes are formed of a refractory metal.

11. The display according to claim 1, wherein the insulating layer is formed of SiO₂.

12. The display according to claim 11 wherein the first hollow comprises a frustoconical surface having an angle of about 26.5°.

13. The display according to claim 1, wherein the electron emitter is formed of one of conductor, semiconductor, and diamond-like carbon (DLC).

14. The display according to claim 1, wherein the first and second electrodes act as a control gate and a gate electrode, respectively.

15. The display according to claim 1, wherein the electron emitter has a micro-rough or micro-abraded surface.

16. A method of fabricating a field emission display on a glass substrate, comprising the steps of:
forming an electron emitter on the glass substrate;
forming a first electrode on the electron emitter, having a first hollow substantially on the center thereon,
forming an insulating layer on the first electrode;
forming a second electrode on the insulating layer; and
forming a second hollow in the insulating layer in the vicinity of the first hollow.

17. The method according to claim 16, further comprising the step of cleaning the surface of the electron emitter prior to the step of forming the first electrode.

18. The method according to claim 16, wherein the step of cleaning the surface of the electron emitter is performed using a TCE solution, ethanol, and deionized water.

19. The method according to claim 16, wherein the step of forming an electron emitter includes a Cs⁺ ion assisted sputtering process.

20. The method according to claim 16, wherein the steps of forming first and second electrodes includes a DC magnetron sputtering process.

21. The method according to claim 16, wherein the step of forming an insulating layer includes at least one of e-beam evaporation, RF magnetron sputtering, and ion beam assisted evaporation processes.

22. The method according to claim 16, wherein the step of forming a first electrode comprises:
forming a refractory metal layer on the electron emitter;
forming a photoresist layer on the refractory metal layer except for a portion to be removed;
dry-etching a first amount of the exposed portion of the refractory metal layer; and
wet-etching a second amount of the exposed portion of the refractory metal layer.

23. The method according to claim 22, wherein the first amount is substantially greater than the second amount.

24. The method according to claim 16, wherein the step of forming an insulating layer comprises:
forming a first SiO₂ layer on the first electrode; and
planarizing the first SiO₂ layer.

25. The method according to claim 16, wherein the step of planarizing the first SiO₂ layer comprises:
forming a photoresist layer on the first SiO₂ layer and filling the first hollow by the photoresist layer; and
etching the photoresist layer and the first SiO₂ layer at the same etch rate, thereby substantially exposing the first SiO₂ layer.

26. The method according to claim 16, wherein the step of forming a second electrode comprises:
forming a refractory metal layer on the first SiO₂ layer;
forming a second SiO₂ layer as a mask on the refractory metal layer except for a portion for the third hollow; and
forming a third hollow in the second electrode.

27. The method according to claim 16, wherein first electrode, the insulating layer, and the second electrode have a relative thickness ratio of 1:3:2.

28. The method according to claim 16, wherein a thickness of the first electrode and a diameter of the third hollow have a relative ratio of 1:1.5.

29. The method according to claim 16, wherein the first, second, and third hollows are frustoconical, segmented ball, and segmented cylindrical shapes, respectively.

30. The method according to claim 16, wherein the first hollow has first and second diameters and the third hollow has a third diameter, wherein the second diameter is greater than the first diameter and the first diameter is greater than the third diameter.

31. The method according to claim 30, wherein the first diameter is twice greater than a thickness of the first electrode.

32. The method according to claim 30, wherein the first diameter of the first hollow exposes a portion of the DLC layer.

33. The method according to claim 30, wherein the first and third diameters have a relative ratio 1:0.75.

34. The method according to claim 30, wherein the first diameter is substantially the same as the shortest distance between the first and second diameter along a frustoconical surface of the first hollow.

35. The method according to claim 16, wherein the electron emitter has a thickness of 250 to 350 Å.

36. The method according to claim 16, wherein the first and second layers are formed of molybdenum.

37. The method according to claim 16, wherein the first and second electrodes are formed under a vacuum condition of below 2×10⁻⁵ Torr, an Ar gas flow rate of 10 sccm, and a pressure of 5 mTorr.

38. The method according to claim 22, further comprising the step of baking the photoresist layer at 170° C. for 10 minutes after the step of forming a photoresist layer for lowering a side angle of the photoresist layer.

39. The method according to claim 22, further comprising the step of O₂ plasma processing to after the step of dry-etching for removing a photoresist residue formed during the step of dry-etching.

40. The method according to claim 39, wherein the step of O₂ plasma processing is carried out for 30 seconds at a pressure of 20 mTorr and a 500 W inductive power by an inductively coupled plasma equipment.

41. The method according to claim 22, wherein the step of dry-etching is carried out at an inductive power of 400 W, a bias voltage of about 150 V, a process pressure of 20 mTorr, and a substrate temperature of 70° C. using a pure Cl₂ gas.

42. The method according to claim 22, wherein the step of wet-etching is carried out by using a solution having 38 H₃PO₄+15HNO₃+30CH₃COO+75H₂O mixed at a ratio of 6:7.6:3:15 when the DLC layer serves as an etch stopper.

43. The method according to claim 22, wherein the first amount is reached when the refractory metal layer is etched to have a thickness of about 500 Å.

44. The method according to claim 16, further comprising the step of cleaning a surface of the first electrode prior to forming an insulating layer by using in an order of TCE, acetone, alcohol, and deionized water.

45. The method according to claim 16, wherein the step of forming an insulating layer includes at least one of e-beam evaporation, RF reactive magnetron sputtering, and ion beam assisted evaporation processes.

46. The method according to claim 45, wherein the e-beam evaporation process is carried out under an initial vacuum condition of below 2×10⁻⁵ Torr, an acceleration voltage of 3.2 KV, a current of 50 to 60 mA, and a substrate temperature in a range of 200° C. to 600° C.

47. The method according to claim 45, wherein the RF magnetron sputtering process is performed under an initial vacuum condition of below 2×10⁻⁵ Torr, an Ar gas flow rate of 10 sccm, an O₂ gas flow rate of 0.5 sccm, a RF power of 200 W, and a process pressure of 10 mTorr.

48. The method according to claim 45, wherein the ion beam assisted evaporation process is carried out under an initial vacuum condition of below 9×10⁻⁶ Torr, an acceleration voltage of 5.5 KV, a current of 50 to 60 mA by using O₂⁺ ions as an ion beam source produced at a RF power of 100 W and an ion acceleration voltage of 900 V.

49. The method according to claim 16, wherein the step of forming an insulating layer includes using a RF magnetron sputtering process to deposit the insulating layer up to a thickness of 3000 Å and using an e-beam or ion-beam assisted evaporation process to complete the deposition of the insulating layer.

50. The method according to claim 16, wherein the step of forming an insulating layer is carried out at a substrate temperature of 600° C. and a deposition rate of 3 Å/s.

51. The method according to claim 16, wherein the step of planarizing the first SiO₂ layer is carried out using a magnetically enhanced inductively coupled plasma equipment at an inductive power of 1000 W and a bias voltage of about 100 V in an etch gas of 90% CF₄ and 10% O₂.

52. The method according to claim 16, wherein the step of forming a second electrode includes a DC magnetron sputtering process under an initial vacuum of below 2×10⁻⁵ Torr, an Ar gas flow rate of 10 sccm, and a process pressure of 5 mTorr.

53. The method according to claim 26, wherein the step of forming a second SiO₂ layer includes a RF magnetron sputtering process to have a thickness of 3500 Å.

54. The method according to claim 16, further comprising the step of patterning the SiO₂ layer using a magnetically enhanced inductively coupled plasma equipment at an inductive power of 1000 W and a bias voltage of about 100 V using an etch gas of CF₄ after the step of forming a second SiO₂ layer.

55. The method according to claim 26, wherein the step of forming the third hollow includes an dry-etching process using an inductively coupled plasma equipment at an inductive power of 400 V, a bias voltage of about 150 V, a substrate temperature of 70° C., and a process pressure of 20 Torr using a mixture of Cl₂ and O₂ as an etching gas.

56. The method according to claim 55, wherein the mixture of Cl₂ and O₂ gases has a ratio of 1:1.

57. The method according to claim 26, further comprising the step of removing the second SiO₂ layer using an wet-etching using a BOE (6:1) solution after the step of forming the third hollow.

58. The method according to claim 16, wherein the electron emitter has a micro-rough or micro-abraded surface.

59. The method according to claim 58, wherein the micro-rough or micro-abraded surface is formed by one of wet etching, dry etching, and ion beam etching.

60. The method according to claim 59, wherein the ion beam etching is carried out under conditions of negatively biasing the first electrode and positively biasing the second electrode.

61. The method according to claim 16, wherein the first and second electrodes act as a control electrode and a gate electrode, respectively.
